(19) United States
(12) Patent Application Publication
(10) Pub. No.: US 2024/0312149 A1
(43) Pub. Date: Sep. 19, 2024

(54) INFORMATION PROCESSING SYSTEM, NON-TRANSITORY COMPUTER READABLE MEDIUM, AND INFORMATION PROCESSING METHOD

(71) Applicant: FUJIFILM Business Innovation Corp., Tokyo (JP)

(72) Inventor: Junya IKEDA, Kanagawa (JP)

(73) Assignee: FUJIFILM Business Innovation Corp., Tokyo (JP)

(21) Appl. No.: 18/452,709

(22) Filed: Aug. 21, 2023

(30) Foreign Application Priority Data
Mar. 15, 2023 (JP) 2023-040618

(51) Int. Cl. G06T 19/00

(52) U.S. Cl. CPC G06T 19/006

(57) ABSTRACT

An information processing system includes one or multiple processors configured to: identify, from display elements of AR content, 3D model data for an object obtained as a result of comparison with one or more objects among objects, each serving as a subject of a captured image; and replace the identified 3D model data with 3D model data for the object serving as the subject.

### CROSS-REFERENCE TO RELATED APPLICATIONS

This application is based on and claims priority under 35 USC 119 from Japanese Patent Application No. 2023-040618 filed Mar. 15, 2023.

### BACKGROUND

### (i) Technical Field

The present disclosure relates to an information processing system, a non-transitory computer readable medium, and an information processing method.

### (ii) Related Art

A technique is known which creates a 3D operation manual that is a three-dimensional version of an operation manual for assisting user's operation (for example, Japanese Unexamined Patent Application Publication No. 2020-201569 and Japanese Patent No. 6655633). Augmented reality (AR) content including 3D operation manual created using such a technique may include, as display elements, 3D model data to which objects are three-dimensionally converted, and text data which is annotation information.

### SUMMARY

When the 3D model data for an object as a display element of the AR content is changed, an operation to generate new 3D model data for the object after the change involves at least. In contrast, a creator of the AR content has a desire to simplify the operation to change a display element of the AR content.

Aspects of non-limiting embodiments of the present disclosure relate to an information processing system that, when a display element included in AR content is changed, simplifies an operation to generate AR content, as compared to when new 3D model data is generated.

Aspects of certain non-limiting embodiments of the present disclosure address the above advantages and/or other advantages not described above. However, aspects of the non-limiting embodiments are not required to address the advantages described above, and aspects of the non-limiting embodiments of the present disclosure may not address advantages described above.

According to an aspect of the present disclosure, there is provided an information processing system including one or a plurality of processors configured to: identify, from display elements of AR content, 3D model data for an object obtained as a result of comparison with one or more objects among objects, each serving as a subject of a captured image; and replace the identified 3D model data with 3D model data for the object serving as the subject.

### BRIEF DESCRIPTION OF THE DRAWINGS

Exemplary embodiments of the present disclosure will be described in detail based on the following figures, wherein:

FIG. 1 is a diagram illustrating an example of the entire configuration of an information processing system to which an exemplary embodiment is applied;

FIG. 2 is a diagram illustrating an example of a hardware configuration of a user terminal;

FIG. 3 is a diagram illustrating an example of a functional configuration of a controller of the user terminal;

FIG. 4 is a diagram illustrating an example of a functional configuration of a controller of a management server;

FIG. 5 is a flowchart illustrating an example of a process flow of the user terminal;

FIGS. 6A to 6C illustrate specific examples of a user interface displayed on a user terminal when 3D model data indicating a static state of an object among the display elements of AR content is changed, FIG. 6A illustrates a specific example of a screen which is among the user interfaces displayed on the user terminal, and on which the AR content including 3D model data for an object before the change is displayed, FIG. 6B illustrates a specific example of a screen which is among the user interfaces displayed on the user terminal, and displayed when an image of an object after the change is captured, and FIG. 6C illustrates a specific example of a screen which is among the user interfaces displayed on the user terminal, and on which a candidate for an object after the change is displayed;

FIGS. 7A and 7B illustrate specific examples of change in database which accompanies change in the display elements of the AR content, FIG. 7A illustrates a specific example of information stored in a database at a timing before a display element of the AR content is changed, and FIG. 7B illustrates a specific example of information stored in a database at a timing after a display element of the AR content is changed;

FIGS. 8A to 8C illustrate specific examples of a user interface displayed on the user terminal when 3D model data showing a dynamic state of an object among the display elements of the AR content is changed, FIG. 8A illustrates a specific example of a screen which is among the user interfaces displayed on the user terminal, and on which the AR content including 3D model data for an operation of an object before the change is displayed, FIG. 8B illustrates another specific example of a screen which is among the user interfaces displayed on the user terminal, and displayed when an image of an object after the change is captured, and FIG. 8C illustrates a specific example of a screen displayed on the user terminal when there is no candidate for 3D model data after the change;

FIGS. 9A to 9C illustrate specific examples of a user interface displayed on the user terminal when 3D model data showing a dynamic state of an object among the display elements of the AR content is changed, FIG. 9A illustrates a specific example of a screen displayed on the user terminal when a candidate for 3D model data after the change is generated, FIG. 9B illustrates a specific example of a screen in which 3D model data for an operation is changed, and FIG. 9C illustrates a specific example of annotation information with content changed according to the change in the 3D model data for an operation; and

FIGS. 10A and 10B illustrate other specific examples of change in database which accompanies change in the display elements of the AR content, FIG. 10A illustrates a specific example of information stored in a database at a timing before a display element of the AR content is changed, and FIG. 10B illustrates a specific example of information stored in a database at a timing after a display element of the AR content is changed.

### DETAILED DESCRIPTION

Hereinafter, an exemplary embodiment of the present disclosure will be described in detail with reference to the accompanying drawings.

### <Entire Configuration of Information Processing System>

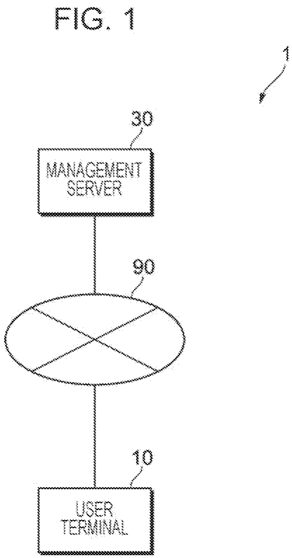

FIG. 1 is a diagram illustrating an example of the entire configuration of an information processing system 1 to which an exemplary embodiment is applied. The information processing system 1 is constituted by connecting a user terminal 10, and a management server 30 via a network 90. The network 90 is, for example, a local area network (LAN), or the Internet.

### (User Terminal)

The user terminal 10 is an information processing device, such as a smartphone, a tablet terminal, a head mount display (HMD), operated by a user who utilizes the information processing system 1. The user terminal 10 identifies, from the display elements of AR content, the 3D model data for an object obtained as a result of comparison with one or more objects among the objects, each serving as the subject of a captured image. Here, the “AR content” refers to content to which the technology of augmented reality (AR) is applied. The user terminal 10 replaces the 3D model data for the object identified from the display elements of the AR content with the 3D model data for an object serving as the subject of a captured image.

The “captured image” refers to a static image or dynamic image captured. The “object” refers to a matter or a person. The “object obtained as a result of comparison” refers to an object which is recognized as similar to the original one because the point of agreement between feature values, such as shape and color, exceeds a predetermined criterion, for example. The “AR content” refers to content to which AR is applied.

The “display elements” refer to elements displayed in the AR content, and includes at least one of 3D model data showing a static state of an object, and 3D model data showing a dynamic state of an object. The 3D model data showing a static state of an object is, for example, 3D model data for an object that undergoes an operation. In addition, the 3D model data showing a dynamic state of an object is, for example, 3D model data for at least part of the body of a worker who performs an operation.

When the 3D model data for an object serving as the subject of a captured image is present in a predetermined database, the user terminal 10 uses the data. In contrast, when the 3D model data for an object serving as the subject of a captured image is not present in the database, the user terminal 10 generates 3D model data for the object. Here, the “predetermined database” refers to a database stored in the storage of the user terminal 10, a database stored in the storage of the management server 30, or a database stored in an external server which is accessible via the network 90.

When identifying, from the display elements of the AR content, the 3D model data for an object obtained as a result of comparison with one or more objects among the objects, each serving as the subject of a captured image, the user terminal 10 displays the 3D model data in the AR content in a manner distinguishable from other display elements.

In addition, when identifying, from the display elements of the AR content, the 3D model data for an object obtained as a result of comparison with one or more objects among the objects, each serving as the subject of a captured image, the user terminal 10 receives an operation for ordering whether the 3D model data should be replaced with the 3D model data for an object serving as the subject of a captured image.

When identifying, from the display elements of the AR content, text data related to an object obtained as a result of comparison with one or more objects among the objects, each serving as the subject of a captured image, the user terminal 10 corrects the text data based on the information on the object serving as the subject of a captured image. Specifically, the user terminal 10 corrects the text data based on information indicating details of the operation of the object serving as the subject of a captured image, the information being used as the “information on the object serving as the subject of a captured image”. Note that the configuration and the details of the process of the user terminal 10 will be described below.

### (Management Server)

The management server 30 included in the information processing system 1 is an information processing apparatus that manages the entire information processing system 1. The management server 30 stores and manages, for example, 3D model data for objects in a database.

The above-described configuration of the information processing system 1 is an example, and it is sufficient that the functions to implement the above-described processes be provided by the information processing system 1 in its entirety. Thus, part or all of the functions to implement the above-described processes may be shared or collaborated in the information processing system 1. Specifically, part or all of the functions of the user terminal 10 may be the functions of the management server 30, and part of all of the functions of the management server 30 may be the functions of the user terminal 10. In addition, part or all of the functions of each of the user terminal 10 and the management server 30 included in the information processing system 1 may be transferred to another server which is not illustrated, and the server may perform part of all of the above-described processes. Thus, the processes performed by the information processing system 1 in its entirety are promoted, and the processes can be supplemented.

### <Hardware Configuration>

### (Hardware Configuration of User Terminal)

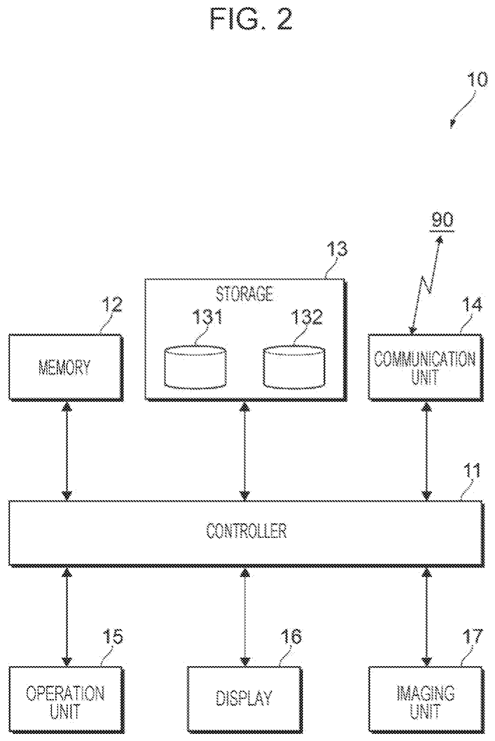

FIG. 2 is a diagram illustrating an example of a hardware configuration of the user terminal 10. The user terminal 10 has a controller 11, a memory 12, a storage 13, a communication unit 14, an operation unit 15, a display 16, and an imaging unit 17. These components connected by a data bus, an address bus, or a Peripheral Component Interconnect (PCI) bus.

The controller 11 is a processor that controls the function of the management server 30 through execution of various software such as OS (basic software) and application software (applied software). The controller 11 is comprised of, for example, a central processing unit (CPU). The memory 12 is a storage area to store various software and data used for execution of the software, and is used as a work area when calculation is performed. The memory 12 is comprised of, for example, a random access memory (RAM).

The storage 13 is a storage area to store input data to various software and output data from various software. The storage 13 is comprised of, for example, a hard disk drive (HDD), a solid state drive (SSD), and a semiconductor memory which are used to store programs and various setting data. The storage 13 includes a database that stores various information. For example, 3D model DB 131 that stores 3D model data for objects, and AR content DB 132 that stores information on AR content are stored as the databases in the storage 13.

The communication unit 14 transmits and receives data between the user terminal 10 and the outside via the network 90. The operation unit 15 is comprised of, for example, a keyboard, a mouse, and mechanical buttons, switches, and receives an input operation. The operation unit 15 may include a touch sensor that forms a touch panel integrally with the display 16. The display 16 is comprised of, for example, a liquid crystal display or an organic electro luminescence (EL) display used to display information, and displays image (dynamic image and static image) data, and text data. The imaging unit 17 is comprised of a camera or the like, and captures a subject displayed on the display 16 that functions as the finder of the camera, and obtains data of a dynamic image or a static image.

### (Hardware Configuration of Management Server)

The hardware configuration of the management server 30 has the same components as in the remaining components after excluding the imaging unit 17 from the hardware configuration of the user terminal 10 illustrated in FIG. 2. Specifically, the management server 30 includes a controller, a memory, a storage, a communication unit, an operation unit, and a display that have the same functions as those of the controller 11, the memory 12, the storage 13, the communication unit 14, the operation unit 15, and the display 16 in FIG. 2, thus illustration and description are omitted.

### <Functional Configuration>

### (User Terminal)

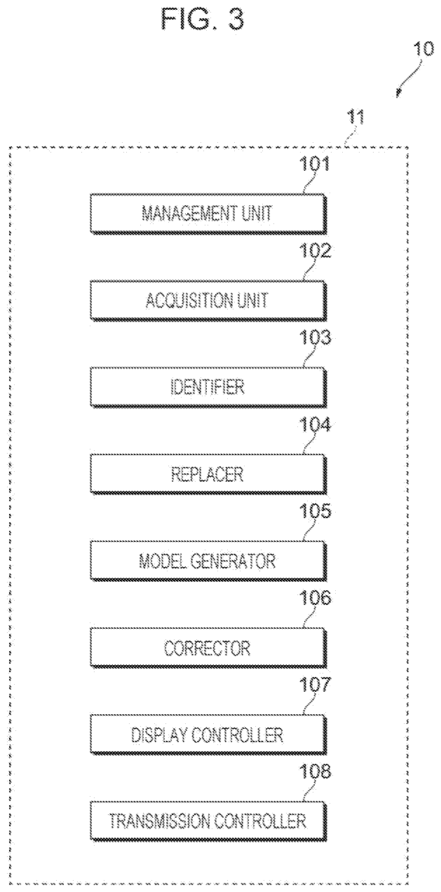

FIG. 3 is a diagram illustrating an example of the functional configuration of the controller 11 of the user terminal 10. A management unit 101, an acquisition unit 102, an identifier 103, a replacement unit 104, a model generator 105, a corrector 106, a display controller 107, and a transmission controller 108 function in the controller 11 of the user terminal 10.

The management unit 101 stores and manages various information in the database of the storage 13 (see FIG. 2). For example, the management unit 101 stores and manages the 3D model data for objects in the 3D model DB 131 of the storage 13. In addition, the management unit 101 stores and manages information on the AR content in the AR content DB 132 of the storage 13.

The acquisition unit 102 acquires various information. For example, the acquisition unit 102 acquires data of an image captured by the imaging unit 17 (FIG. 2). In addition, the acquisition unit 102 acquires input information which is received via the operation unit 15 (see FIG. 2) by a user. In addition, the acquisition unit 102 acquires various information transmitted from each of the management server 30 and the outside. Of the information acquired by the acquisition unit 102, the information transmitted from the management server 30 includes, for example, 3D model data, and the display elements of the AR content.

The identifier 103 identifies, from the display elements of the AR content, the 3D model data for an object obtained as a result of comparison with one or more objects among the objects, each serving as the subject of an image captured by the imaging unit 17. For example, the identifier 103 identifies, from the display elements of the AR content, the 3D model data for an object which is recognized as similar to one or more objects among the objects, each serving as the subject of a captured image.

In addition, the identifier 103 identifies, from the display elements of the AR content, text data related to an object obtained as a result of comparison with one or more objects among the objects, each serving as the subject of an image captured by the imaging unit 17. For example, the identifier 103 identifies, from the display elements of the AR content, text data related to an object which is recognized as similar to one or more objects among the objects, each serving as the subject of a captured image. Here, the “text data related to an object” is, for example, annotation information as a display element of the AR content.

The replacement unit 104 replaces the 3D model data for the object identified by the identifier 103 with the 3D model data for the object serving as the subject of an image captured by the imaging unit 17. The 3D model data for the object serving as the subject of an image captured by the imaging unit 17 is acquired from the database (the 3D model DB 131 in FIG. 2) stored in the storage 13 of the user terminal 10, the database stored in the storage of the management server 30, or the database stored in a server or the like accessible via the network 90.

The model generator 105 generates 3D model data for an object. Specifically, when the 3D model data for an object serving as the subject of an image captured by the imaging unit 17 is not present, the model generator 105 generates the 3D model data for the object. Here, “is not present” refers to, for example, the case where 3D model data is not stored in the 3D model DB 131 of the storage 13, the case where 3D model data is not stored in the storage of the management server 30, and the case where 3D model data is not acquirable from an external server or the like accessible via the network 90.

The corrector 106 corrects the text data related to the object identified by the identifier 103 based on the information on the object serving as the subject of a captured image. Specifically, the user terminal 10 corrects the text data of annotation information based on, for example, information indicating the details of the operation of the object serving as the subject of a captured image or information showing the name of the object, the information serving as “the information on the object serving as the subject of a captured image”.

The display controller 107 performs control to display various information on the display 16 (see FIG. 2). For example, the display controller 107 performs control to display, in the AR content, the 3D model data for the object identified by the identifier 103 as a candidate for replacement in a selectable manner. In addition, the display controller 107 performs control to display, in the AR content, the 3D model data for the object identified by the identifier 103 in a manner distinguishable from other display elements. The “distinguishable manner” indicates, for example, highlight.

The transmission controller 108 performs control to transmit various information. Specifically, the transmission controller 108 performs control to transmit various information to each of the management server 30 and the outside. Of the information for which transmission is controlled by the transmission controller 108, the information transmitted to the management server 30 includes, for example, information inputted for inquiry of 3D model data, and information inputted for inquiry of a display element of the AR content.

### (Management Server)

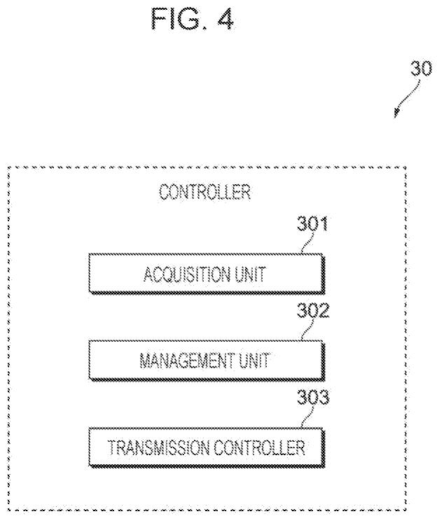

FIG. 4 is a diagram illustrating an example of the functional configuration of the controller of the management server 30. An acquisition unit 301, a management unit 302, and a transmission controller 303 function in the controller of the management server 30.

The acquisition unit 301 acquires various information. Specifically, the acquisition unit 301 acquires various information transmitted from the user terminal 10 and the outside. Of the information acquired by the acquisition unit 301, the information transmitted from the user terminal 10 includes, for example, information inputted for inquiry of 3D model data, and information inputted for inquiry of a display element of the AR content.

The management unit 302 stores and manages various information in the database of the storage. For example, the management unit 302 stores and manages the 3D model data for objects and the display elements of the AR content in a database.

The transmission controller 303 performs control to transmit various information. Specifically, the transmission controller 303 performs control to transmit various information to the user terminal 10 and the outside. Of the information for which transmission is controlled by the transmission controller 303, the information transmitted to the user terminal 10 includes, for example, 3D model data for objects and a display element of the AR content.

### <Process Flow>

### (Process Flow of User Terminal)

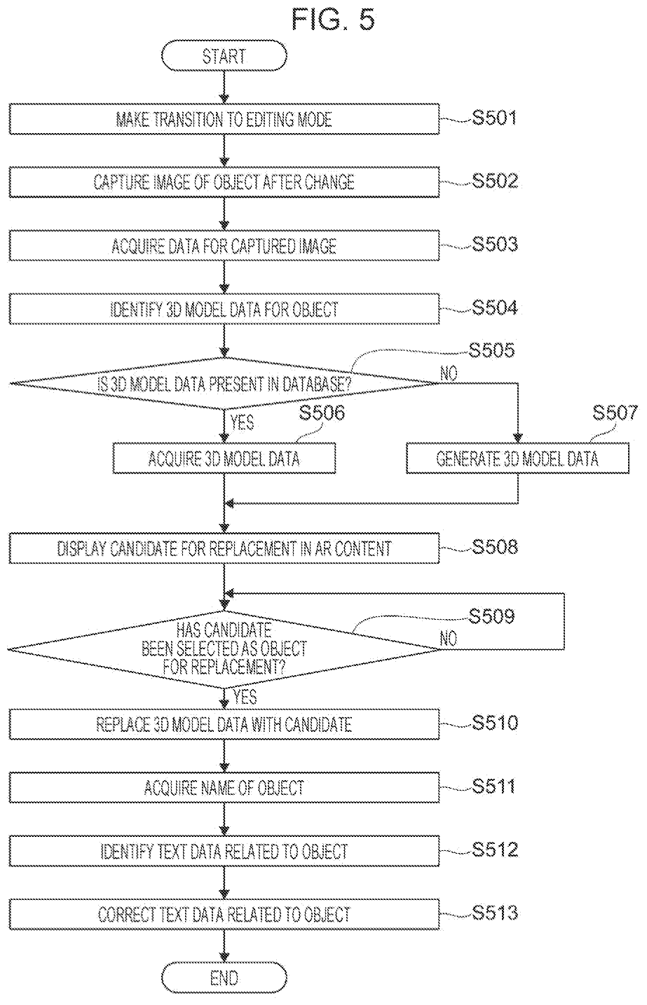

FIG. 5 is a flowchart illustrating an example of the process flow of the user terminal 10. The user terminal 10 makes transition to an editing mode based on an operation of a user (step 501). Specifically, upon operation of selection whether the object after the change indicates a static state or a dynamic state in a situation where there is a 3D model which is desired to be changed by a user among the details of the AR content, transition is made to an editing mode.

Next, the user terminal 10 captures the image of the object after the change based on an operation of a user (step 502), and acquires the data of the captured image (step 503). The user terminal 10 then identifies the 3D model data (step 504). Specifically, the user terminal 10 identifies, from the display elements of the AR content, the 3D model data for an object obtained as a result of comparison with one or more objects among the objects, each serving as the subject of a captured image.

Subsequently, when the 3D model data for the object identified in step 504 is present (YES in step 505), the user terminal 10 acquires the 3D model data (step 506), and the flow proceeds to step 508. In contrast, when the 3D model data for the identified object is not present (NO in step 505), the user terminal 10 generates 3D model data for the object (step 507), and the flow proceeds to step 508.

The user terminal 10 displays a candidate for replacement in the AR content (step 508). Specifically, the user terminal 10 displays the 3D model data acquired in step 506 or generated in step 507 in the AR content as a candidate for replacement in a selectable manner.

When the 3D model data displayed in the AR content in step 508 is selected as a target for replacement (YES in step 509), the user terminal 10 replaces the 3D model data for the object included in the AR content (step 510). Specifically, the user terminal 10 replaces the 3D model data for the object identified in step 504 with the 3D model data for the object selected in step 509. In contrast, when the 3D model data displayed in the AR content in step 508 is not selected as a target for replacement (NO in step 509), the user terminal 10 repeats the determination process in step 509.

Subsequently, the user terminal 10 acquires the name of the object, for which the 3D model data has been acquired in step 506 or generated in step 507 (step 511), and identifies the text data related to the object from the display elements of the AR content (step 512). For example, the user terminal 10 identifies the annotation information as a display element of the AR content.

The user terminal 10 then corrects the identified text data related to the object (step 513). Specifically, the user terminal 10 corrects the identified text data related to the object based on the information on the object serving as the subject of a captured image. For example, the user terminal 10 corrects the text data of annotation information based on information indicating the details of the operation of the object serving as the subject of a captured image or information showing the name of the object.

### Specific Examples

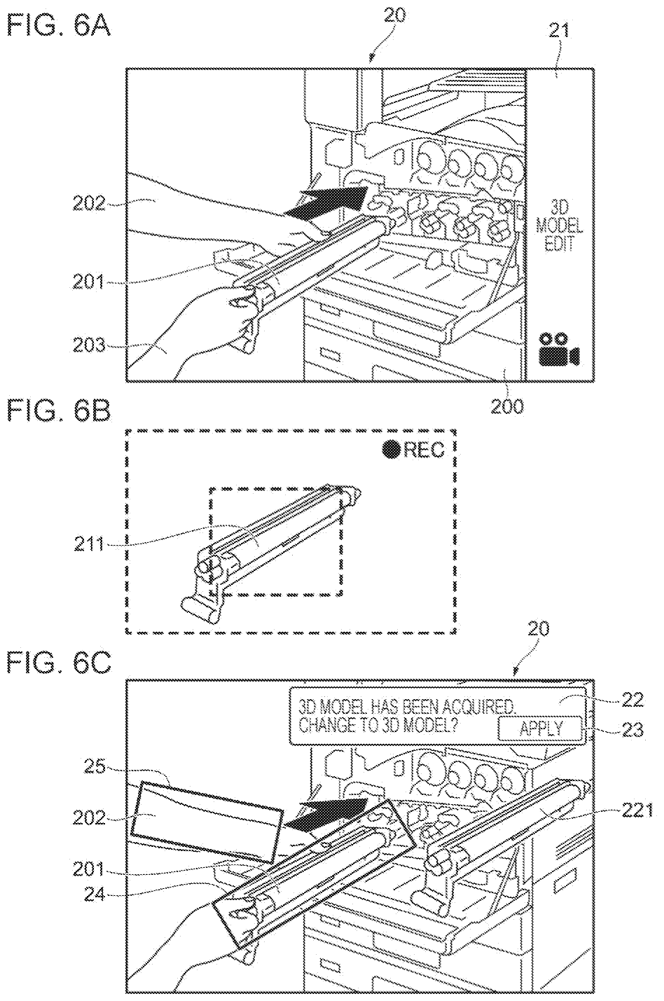

FIGS. 6A to 6C illustrate specific examples of a user interface displayed on the user terminal 10 when 3D model data showing a static state of an object among the display elements of the AR content is changed. FIG. 6A illustrates a specific example of a screen which is among the user interfaces displayed on the user terminal, and on which the AR content including 3D model data for an object before the change is displayed. AR content 20 displayed on the screen illustrated in FIG. 6A is for the purpose of assisting an operation of replacing a cartridge of an MFP as an image processing apparatus. Thus, the AR content 20 includes, as the display elements, an MFP 200, 3D model data 201 for a blue cartridge, 3D model data 202 for the left hand of an operator, and 3D model data 203 for the right hand of the operator.

When the AR content 20 is displayed on the user terminal 10, as illustrated in FIG. 6A, a button 21 labeled with “3D MODEL EDIT” is displayed to be superimposed on the AR content 20, or in the vicinity of the AR content 20. The button 21 is to be depressed by a user when 3D model data as a display element of the AR content 20 is changed. When the button 21 is depressed, the screen illustrated in FIG. 6B is displayed.

FIG. 6B illustrates a specific example of a screen which is among the user interfaces displayed on the user terminal 10, and displayed when an image of an object after the change is captured. The screen illustrated in FIG. 6B shows an example of a screen displayed when the 3D model data 201 for a blue cartridge as a display element of the AR content 20 in FIG. 6A is changed, and a pink cartridge 211 after the change is captured. When the pink cartridge 211 as an actual product is captured, the screen illustrated in FIG. 6C is displayed.

FIG. 6C illustrates a specific example of a screen which is among the user interfaces displayed on the user terminal 10, and on which a candidate for an object after change is displayed. The AR content 20 displayed on the screen illustrated in FIG. 6C shows a message 22 stating that “3D MODEL HAS BEEN ACQUIRED. CHANGE TO 3D MODEL?”, and a button 23 labeled with “APPLY” in a superimposed manner in addition to the display elements illustrated in FIG. 6A. In addition, in the AR content 20, frame lines 24 and 25 indicating respective pieces of 3D model data for one or more objects among the display elements are displayed in a superimposed manner. The frame line 24 between these frame lines indicates the 3D model data 201 for a blue cartridge, and the frame line 25 indicates the 3D model data 202 for the left hand of an operator. In addition, in the AR content 20, 3D model data 221 for a pink cartridge as a candidate for change is displayed in a superimposed manner.

When the 3D model data 201 for a blue cartridge as a display element of the AR content is changed to the 3D model data 221 for a pink cartridge displayed as a candidate for change, a user depresses the button 23. Then the 3D model data 201 for a blue cartridge is automatically determined to be a target for change, and the 3D model data 201 for a blue cartridge is replaced with the 3D model data 221 for a pink cartridge.

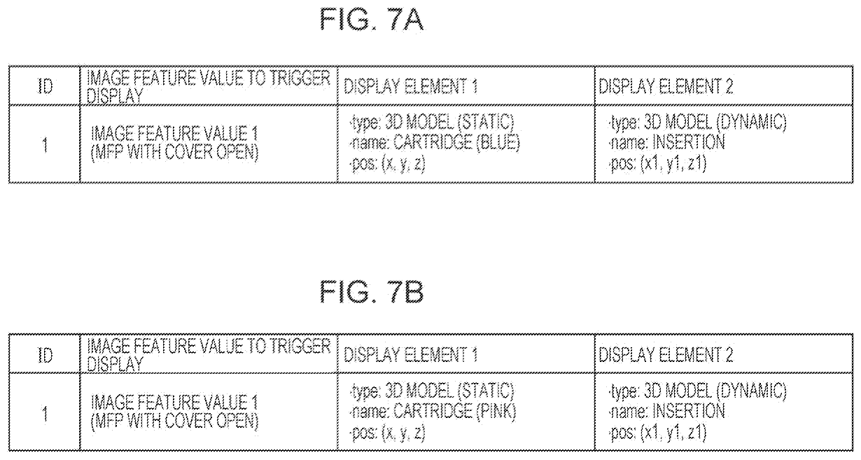

FIGS. 7A and 7B illustrate specific examples of change in database which accompanies change in the display elements of the AR content. FIG. 7A illustrates a specific example of information stored in a database at a timing before a display element of the AR content is changed. FIG. 7B illustrates a specific example of information stored in a database at a timing after a display element of the AR content is changed. Note that the “database” herein refers to the AR content DB 132 (see FIG. 2) stored in the storage 13 of the user terminal 10.

The above-mentioned AR content DB 132 in FIG. 2 stores, as the information on the AR content, information indicating the display elements of each AR content. Specifically, as illustrated in FIGS. 7A and 7B, “IMAGE FEATURE VALUE TO TRIGGER DISPLAY”, “DISPLAY ELEMENT 1” and “DISPLAY ELEMENT 2” are stored in association with “ID” as identification information capable of uniquely identifying AR content. Here, the “ID” of the AR content illustrated in FIGS. 6A to 6C mentioned above is assumed to be “1”.

At a timing before a display element of the AR content is changed, as illustrated in FIG. 7A, “IMAGE FEATURE VALUE TO TRIGGER DISPLAY” of the AR content with “ID” of “1” is “IMAGE FEATURE VALUE 1 (MFP WITH COVER OPEN)”. In addition, “DISPLAY ELEMENT 1” provides “type: 3D MODEL” (STATIC)”, “name: CARTRIDGE (BLUE)”, and “pos:(x, y, z)”, and “DISPLAY ELEMENT 2” provides “type: 3D MODEL” (DYNAMIC)”, “name: INSERTION”, and “pos:(x1, y1, z1)”. Of these, “type” indicates 3D model data showing a static state of an object, or 3D model data showing a dynamic state of an object, and “name” indicates the name of an object. In addition, “pos” indicates the position where 3D model data is displayed.

Specifically, “DISPLAY ELEMENT 1” of the AR content with “ID” of “1” is the 3D model data for a blue cartridge of MFP, and corresponds to the above-mentioned 3D model data 201 for a blue cartridge in FIG. 6A. In addition, “DISPLAY ELEMENT 2” is 3D model data that indicates an operation of “INSERTION” of an object, and corresponds to the above-mentioned 3D model data 202 that indicates the movement of the left arm of an operator in FIG. 6C.

In contrast, at a timing after a display element of the AR content is changed, as illustrated in FIG. 7B, “name: CARTRIDGE (BLUE)” of “DISPLAY ELEMENT 1” has been changed to “name: CARTRIDGE (PINK)”, and other information is the same as in FIG. 7A. This indicates that before and after the change of “DISPLAY ELEMENT 1” of the AR content, a blue cartridge has been changed to a pink cartridge. In other words, this indicates that the above-mentioned 3D model data 201 for a blue cartridge in FIG. 6A has been replaced with the 3D model data 221 for a pink cartridge in FIG. 6C, and no change has been made in the operation of inserting a cartridge into MFP by an operator.

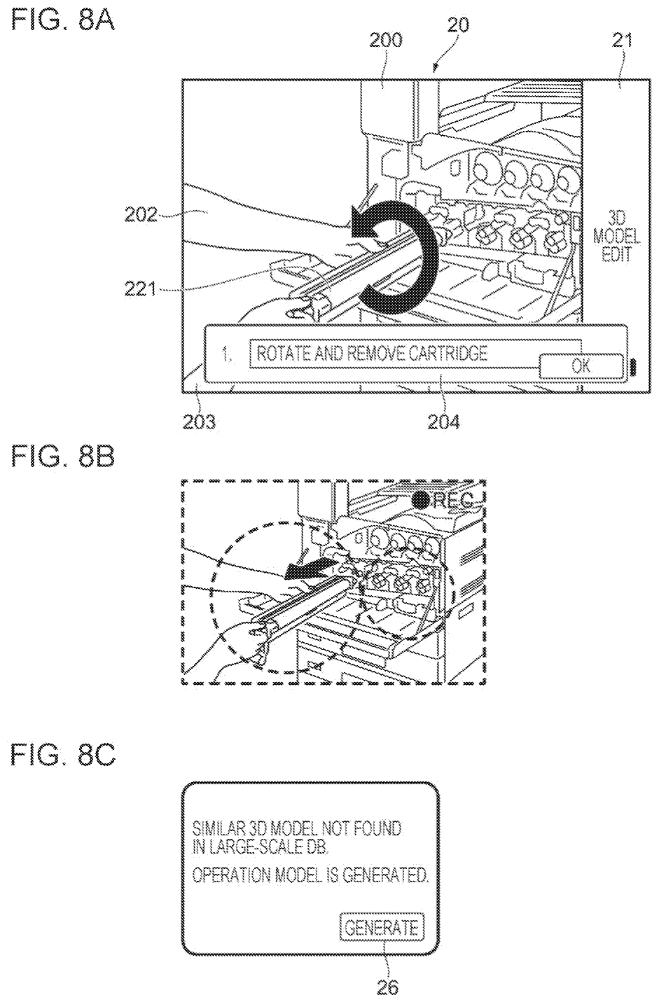

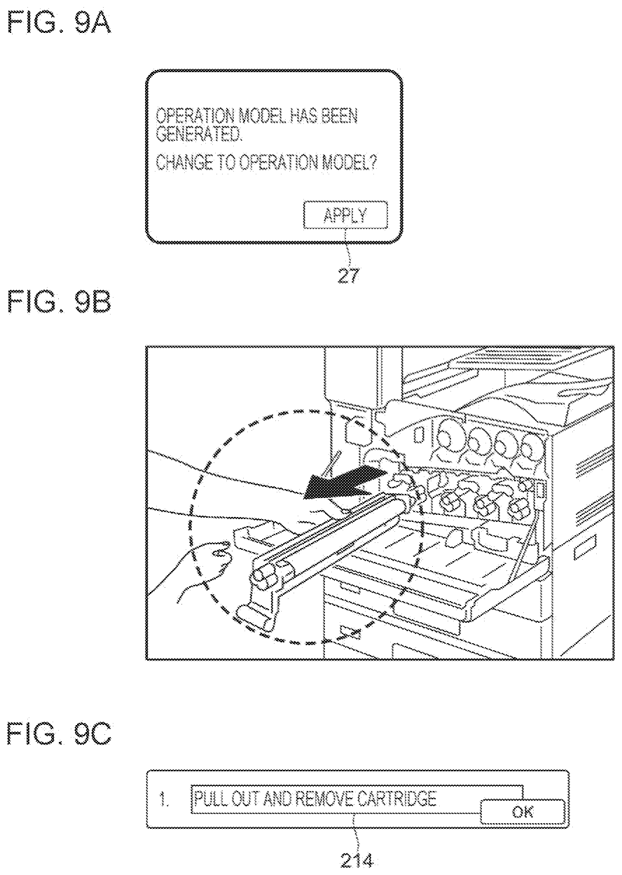

FIGS. 8A-8C to 9A-9C illustrate specific examples of a user interface displayed on the user terminal 10 when 3D model data showing a dynamic state of an object among the display elements of the AR content is changed. FIG. 8A illustrates a specific example of a screen which is among the user interfaces displayed on the user terminal 10, and on which the AR content including 3D model data for an operation of an object before the change is displayed.

As in the above-described example of FIGS. 6A to 6C, the AR content 20 displayed on the screen illustrated in FIG. 8A is for the purpose of assisting an operation of replacing a cartridge of an MFP as an image processing apparatus. Thus, the AR content 20 includes, as the display elements, the MFP 200, the 3D model data 221 for a pink cartridge, the 3D model data 202 for the left hand of an operator, and the 3D model data 203 for the right hand of the operator. In addition, annotation information 204 including text data indicating “ROTATE AND REMOVE CARTRIDGE” is also included in the display elements. When the button 21 labeled with “3D MODEL EDIT” is depressed with the AR content 20 displayed on the user terminal 10, the screen illustrated in FIG. 8B is displayed.

FIG. 8B illustrates another specific example of a screen which is among the user interfaces displayed on the user terminal 10, and displayed when an image of an object after the change is captured. The screen illustrated in FIG. 8B shows an example of a screen displayed when 3D model data as a display element of the AR content 20 in FIG. 8A for an operation of rotating an object by an operator is changed, and an operation of pulling out an object by an operator is captured as the operation after the change. When an operation of pulling out an object by an operator is captured, and 3D model data for the operation is present, it is proposed that the 3D model data for an operation of rotating an object be replaced with the 3D model data for an operation of pulling out an object. In contrast, when there is no candidate for 3D model data for an operation of pulling out an object by an operator, 3D model data for the operation is generated.

FIG. 8C illustrates a specific example of a screen displayed on the user terminal 10 when there is no candidate for 3D model data after the change. When there is no candidate for 3D model data after the change, for example, as illustrated in FIG. 8C, a message is displayed which states that “SIMILAR 3D MODEL NOT FOUND IN LARGE-SCALE DB. OPERATION MODEL IS GENERATED”. The “LARGE-SCALE DB” indicates the above-mentioned “predetermined database”, and specifically indicates a database stored in the storage of the user terminal 10, a database stored in the storage of the management server 30, or a database stored in an external server which is accessible via the network 90. When the button 26 labeled with “GENERATE” is depressed, generation of 3D model data is started.

FIG. 9A illustrates a specific example of a screen displayed on the user terminal 10 when a candidate for 3D model data after the change is generated. When 3D model data is generated, for example, as illustrated in FIG. 9A, a message is displayed which states that “OPERATION MODEL HAS BEEN GENERATED. CHANGE TO OPERATION MODEL?”. Here, when button 27 labeled with “APPLY” is depressed, the 3D model data for an operation of rotating an object is replaced with the generated 3D model data for an operation of pulling out an object. FIG. 9B illustrates a specific example of a screen in which 3D model data for an operation is changed.

In addition, the content of text data included in the annotation information is changed according to the change in the 3D model data for an operation of an operator. To change the content of text data, for example, a result of machine learning by artificial intelligence (AI) may be used. FIG. 9C illustrates a specific example of annotation information with content changed according to the change in the 3D model data for an operation. Specifically, as illustrated in FIG. 8A described above, annotation information 204 before the change is “ROTATE AND REMOVE CARTRIDGE”, but annotation information 214 after the change is “PULL OUT AND REMOVE CARTRIDGE” as illustrated in FIG. 9C.

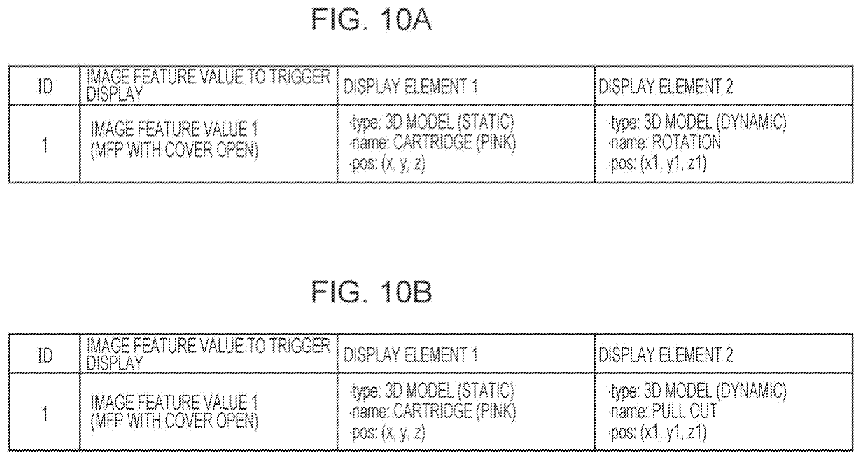

FIGS. 10A and 10B illustrate other specific examples of change in database which accompanies change in the display elements of the AR content. FIG. 10A illustrates a specific example of information stored in a database at a timing before a display element of the AR content is changed. FIG. 10B illustrates a specific example of information stored in a database at a timing after a display element of the AR content is changed. Note that as in the above-described example of FIGS. 7A and 7B, the “database” herein refers to the AR content DB 132 (see FIG. 2) stored in the storage 13 of the user terminal 10.

At a timing before a display element of the AR content is changed, as illustrated in FIG. 10A, “IMAGE FEATURE VALUE TO TRIGGER DISPLAY” of the AR content with “ID” of “1” is “IMAGE FEATURE VALUE 1 (MFP WITH COVER OPEN)”. In addition, “DISPLAY ELEMENT 1” provides “type: 3D MODEL” (STATIC)”, “name: CARTRIDGE (PINK)”, and “pos:(x, y, z)”, and “DISPLAY ELEMENT 2” provides “type: 3D MODEL” (DYNAMIC)”, “name: ROTATION”, and “pos:(x1, y1, z1)”.

Specifically, “DISPLAY ELEMENT 1” of the AR content with “ID” of “1” is the 3D model data for a pink cartridge of MFP as an image processing apparatus, and corresponds to the above-mentioned 3D model data 221 for a pink cartridge in FIG. 8A. In addition, “DISPLAY ELEMENT 2” is 3D model data that indicates an operation of “ROTATION” of an object, and corresponds to the above-mentioned 3D model data that indicates the operation of an operator in FIG. 8A.

In contrast, at a timing after a display element of the AR content is changed, as illustrated in FIG. 10B, “name: ROTATION” of “DISPLAY ELEMENT 2” has been changed to “name: PULL OUT”, and other information is the same as in FIG. 10A. This indicates that before and after the change of “DISPLAY ELEMENT 1” of the AR content, the operation of an operator has been changed from “ROTATION” to “PULL OUT”. In other words, this indicates that the above-mentioned 3D model data for an operation of rotating a cartridge in FIG. 8A has been replaced with the 3D model data for an operation of pulling out a cartridge in FIG. 8B, and no change has been made in the 3D model data for a cartridge.

### Other Exemplary Embodiments

Although the exemplary embodiment has been described above, the present disclosure is not limited to the exemplary embodiment described above. In addition, the effects achieved by the present disclosure are not limited to those described in the exemplary embodiment above. For example, each of the configuration of the information processing system 1 illustrated in FIG. 1, and the hardware configuration of the user terminal 10 illustrated in FIG. 2 is only an illustration to achieve the object of the present disclosure, and is not particularly limited. In addition, the functional configuration of the user terminal 10 illustrated in FIG. 3, and the functional configuration of the management server 30 illustrated in FIG. 4 are only an illustration, and is not particularly limited. It is sufficient that the information processing system 1 in its entirety of FIG. 1 be provided with the function that enables the above-described processes to be executed, and the functional configurations to be used to implement this function are not limited to the examples in FIG. 3 and FIG. 4.

Also, the order of steps of the process performed by the user terminal 10 illustrated in FIG. 5 is only an illustration, and not particularly limited. The process is not only performed in time series in the order of the illustrated steps. The process is not necessarily performed in time series, and may be performed concurrently or individually. In addition, the specific examples illustrated in FIGS. 6A-6C to FIGS. 10A and 10B are only an example, and not particularly limited.

For example, in the above-described exemplary embodiment, the user terminal 10 is configured to perform the process of generating 3D model data, and the process of correcting text data related to an object, but the configuration is not limited to this. These processes may be performed by the information processing system in its entirety, thus, for example, the management server 30 may be configured to perform these processes.

In the embodiments above, the term “processor” refers to hardware in a broad sense. Examples of the processor include general processors (e.g., CPU: Central Processing Unit) and dedicated processors (e.g., GPU: Graphics Processing Unit, ASIC: Application Specific Integrated Circuit, FPGA: Field Programmable Gate Array, and programmable logic device).

In the embodiments above, the term “processor” is broad enough to encompass one processor or plural processors in collaboration which are located physically apart from each other but may work cooperatively. The order of operations of the processor is not limited to one described in the embodiments above, and may be changed.

The foregoing description of the exemplary embodiments of the present disclosure has been provided for the purposes of illustration and description. It is not intended to be exhaustive or to limit the disclosure to the precise forms disclosed. Obviously, many modifications and variations will be apparent to practitioners skilled in the art. The embodiments were chosen and described in order to best explain the principles of the disclosure and its practical applications, thereby enabling others skilled in the art to understand the disclosure for various embodiments and with the various modifications as are suited to the particular use contemplated. It is intended that the scope of the disclosure be defined by the following claims and their equivalents.

### APPENDIX

(((1)))

An information processing system comprising:
one or a plurality of processors configured to:
   identify, from display elements of AR content, 3D model data for an object obtained as a result of comparison with one or more objects among objects, each serving as a subject of a captured image; and
   replace the identified 3D model data with 3D model data for the object serving as the subject.
      (((2)))

The information processing system according to (((1))),
wherein the one or a plurality of processors are configured to, when the 3D model data for the object serving as the subject is not present, generate the 3D model data.
   (((3)))

The information processing system according to (((1))) or (((2))),
wherein the one or a plurality of processors are configured to perform control to display the identified 3D model data in the AR content in a manner distinguishable from other display elements.
   (((4)))

The information processing system according to any one of (((1))) to (((3))),
wherein the one or a plurality of processors are configured to receive an operation for ordering whether the identified 3D model data is replaced with the 3D model data for the object serving as the subject.
   (((5)))

The information processing system according to any one of (((1))) to (((4))),
wherein the display elements include at least one of 3D model data indicating a static state of an object and 3D model data indicating a dynamic state of the object.
   (((6)))

The information processing system according to (((5))),
wherein the 3D model data indicating a static state is 3D model data for an object on which an operation is to be performed, and the 3D model data indicating a dynamic state is 3D model data for at least part of a body of an operator who performs the operation.
   (((7)))

The information processing system according to any one of (((1))) to (((6)
wherein the one or a plurality of processors are configured to:
   identify, from the display elements of the AR content, text data related to the object obtained as a result of comparison with one or more objects among the objects, each serving as the subject; and
correct the identified text data based on information on the object serving as the subject.
   (((8)))

The information processing system according to (((7))),
wherein the one or a plurality of processors are configured to correct the text data based on information indicating details of an operation of the object, as the information on the object serving as the subject.
   (((9)))

A program causing a computer to execute a process comprising:
identifying, from display elements of AR content, 3D model data for an object obtained as a result of comparison with one or more objects among objects, each serving as a subject of a captured image; and
displaying the identified 3D model data in the AR content in a manner distinguishable from other display elements.

What is claimed is:

1. An information processing system comprising:
one or a plurality of processors configured to:
identify, from display elements of AR content, 3D model data for an object obtained as a result of comparison with one or more objects among objects, each serving as a subject of a captured image; and
replace the identified 3D model data with 3D model data for the object serving as the subject.

2. The information processing system according to claim 1,
wherein the one or a plurality of processors are configured to:
when the 3D model data for the object serving as the subject is not present, generate the 3D model data.

3. The information processing system according to claim 1,
wherein the one or a plurality of processors are configured to:
perform control to display the identified 3D model data in the AR content in a manner distinguishable from other display elements.

4. The information processing system according to claim 3,
wherein the one or a plurality of processors are configured to:
receive an operation for ordering whether the identified 3D model data is replaced with the 3D model data for the object serving as the subject.

5. The information processing system according to claim 1,
wherein the display elements include at least one of 3D model data indicating a static state of an object and 3D model data indicating a dynamic state of the object.

6. The information processing system according to claim 5,
wherein the 3D model data indicating a static state is 3D model data for an object on which an operation is to be performed, and the 3D model data indicating a dynamic state is 3D model data for at least part of a body of an operator who performs the operation.

7. The information processing system according to claim 1,
wherein the one or a plurality of processors are configured to:
identify, from the display elements of the AR content, text data related to the object obtained as a result of comparison with one or more objects among the objects, each serving as the subject; and
correct the identified text data based on information on the object serving as the subject.

8. The information processing system according to claim 7,
wherein the one or a plurality of processors are configured to:
correct the text data based on information indicating details of an operation of the object, as the information on the object serving as the subject.

9. A non-transitory computer readable medium storing a program causing a computer to execute a process comprising:
identifying, from display elements of AR content, 3D model data for an object obtained as a result of comparison with one or more objects among objects, each serving as a subject of a captured image; and
displaying the identified 3D model data in the AR content in a manner distinguishable from other display elements.

10. An information processing method comprising:
identifying, from display elements of AR content, 3D model data for an object obtained as a result of comparison with one or more objects among objects, each serving as a subject of a captured image; and
replacing the identified 3D model data with 3D model data for the object serving as the subject.
